(19) United States
(12) Patent Application Publication
(10) Pub. No.: US 2013/0207986 A1
(43) Pub. Date: Aug. 15, 2013

(54) METHOD AND DEVICE FOR ACCESSING BUFFER OF DISPLAY

(71) Applicants: Chen-Long HUANG, Taipei City (TW); Chen An HUANG, Zhonghe City (TW); Shu-Wen TENG, Hsinchu City (TW)

(72) Inventors: Chen-Long HUANG, Taipei City (TW); Chen An HUANG, Zhonghe City (TW); Shu-Wen TENG, Hsinchu City (TW)

(73) Assignee: MediaTek Inc., Hsin-Chu (TW)

(21) Appl. No.: 13/372,939

(22) Filed: Feb. 14, 2012

(51) Int. Cl. G09G 5/36

(52) U.S. Cl. 345/545

(57) ABSTRACT

A method for accessing a buffer of a display is provided, wherein the buffer is capable of storing frame data of at least one frame and the frame has a plurality of lines. A read line position that indicates a line currently being read in the buffer is obtained, wherein the line currently being read is to be shown on a screen of the display. A first time period is delayed to update the buffer when the read line position is smaller than a reference line position.

### BACKGROUND OF THE INVENTION

1. Field of the Invention

The present invention is related to a method for accessing a buffer of a display, and more particularly to a method for accessing a buffer of a display to avoid tearing effect for the display.

2. Description of the Related Art

Nowadays, portable devices equipped with an LCD module (LCM) for displaying an image, video and so on, are common Content to be displayed can be read from a frame buffer and displayed on a screen of the LCM. However, tearing effect is a typical problem for the LCM due to the fact the frame buffer of the LCM is read at a different timing than the updating of the frame buffer of the LCM. As a result, the displayed content on the screen of the LCM may include both the updated and old content.

In order to solve the problem described above, multiple buffers are used and content is cycled through the multiple buffers. Two frame buffers are often used so that data for a new frame is written to one frame buffer while data for a current frame is read from the other frame buffer and provided to the LCD screen. The two frame buffers are operated in a ping-pong manner so that data is retrieved from one frame buffer for an entire frame, then from the other frame buffer for the next frame, then back to the first frame buffer for the following frame, and so on. Data for a new frame is written to the frame buffer that is not being accessed for the screen in the LCM. However, using multiple buffers will increase cost and area requirements for the LCM.

### BRIEF SUMMARY OF THE INVENTION

Methods and devices for accessing a buffer of a display are provided. An embodiment of a method for accessing a buffer of a display is provided, wherein the buffer is capable of storing frame data of at least one frame and the frame has a plurality of lines. A read line position that indicates a line currently being read in the buffer is obtained, wherein the line currently being read is to be shown on a screen of the display. A first time period is delayed to update the buffer when the read line position is smaller than a reference line position.

Furthermore, another embodiment of a method for accessing a buffer of a display is provided, wherein the buffer is capable of storing frame data of at least one frame and the frame has a plurality of lines. A read line position that indicates a line currently being read in the buffer is obtained, wherein the line currently being read is used to refresh a corresponding line of a screen in the display during a refresh cycle. Frame data of a new frame is started being written into the buffer in the refresh cycle when the read line position is smaller than a reference line position. The frame data of the new frame is started being written into the buffer in a next refresh cycle when the read line position is larger than or equal to the reference line position.

Moreover, an embodiment of a display device is provided. The display device comprises an LCD module and a display controller. The LCD module comprises a screen, a buffer and a driver. The buffer is capable of storing frame data of at least one frame to be displayed on the screen, and the frame having a plurality of lines. The driver is capable of reading the frame data from the buffer and transferring the read data to the screen. The display controller writes frame data of a new frame into the buffer via the driver after a specific time period is reached, wherein the specific time period is determined according to a read line position indicating a line of the buffer currently being read by the driver in a refresh cycle.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a display device according to an embodiment of the invention;

FIG. 2 shows a schematic diagram illustrating content mapping between the frame buffer and the LCD screen of FIG. 1;

FIG. 3 shows a method for accessing a buffer of a display according to an embodiment of the invention;

FIG. 4 shows an example illustrating an access status of the frame buffer in FIG. 1 according to an embodiment of the invention; and

FIG. 5 shows another example illustrating an access status of the frame buffer in FIG. 1 according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

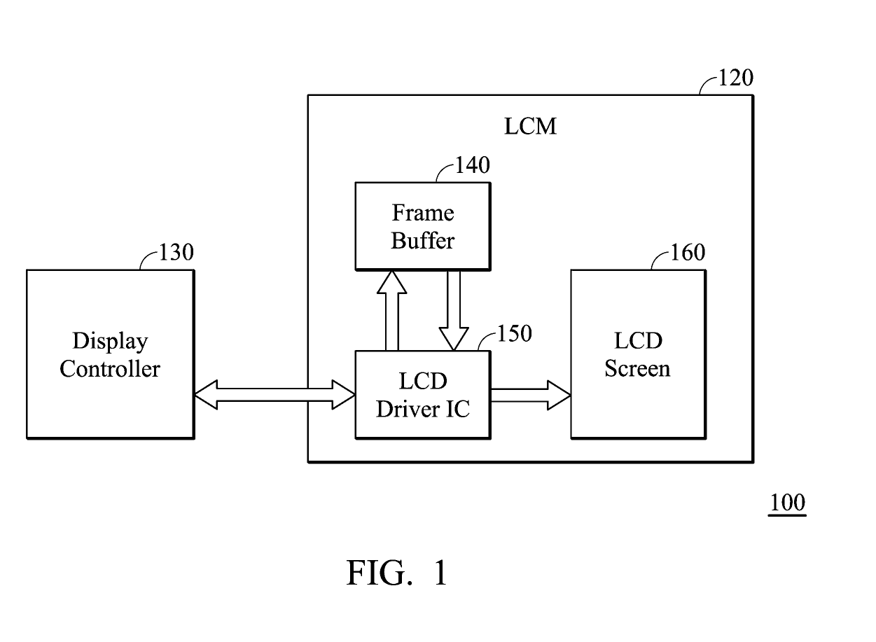

FIG. 1 shows a display device 100 according to an embodiment of the invention. The display device 100 can be included in any devices for displaying contents, such as mobile phone, notebook, tablet, digital camera, portable media player, etc. The display device 100 includes an LCD module (LCM) 120 and display controller 130. The LCM 120 includes a frame buffer 140, an LCD driver IC 150 and an LCD screen 160, wherein the frame buffer 140 has a capacity capable of storing frame data of at least one frame to be displayed on the LCD screen 160. The frame data includes at least a portion of content to be displayed, such as image, video, etc. and can include value of each pixel, such as RGB value of each pixel. In FIG. 1, the display controller 130 is capable of sending frame data of at least one frame to the LCD driver IC 150, and the LCD driver IC 150 is capable of writing the frame data into the frame buffer 140. In addition, the LCD driver IC 150 is capable of reading the frame data from the frame buffer 140 and transferring the read frame data to be displayed to the LCD screen 160. In one embodiment, the timing that the LCD driver IC 150 reads frame data from the frame buffer 140 may be different than the timing that the display controller 130 sends the frame data to the LCM 120.

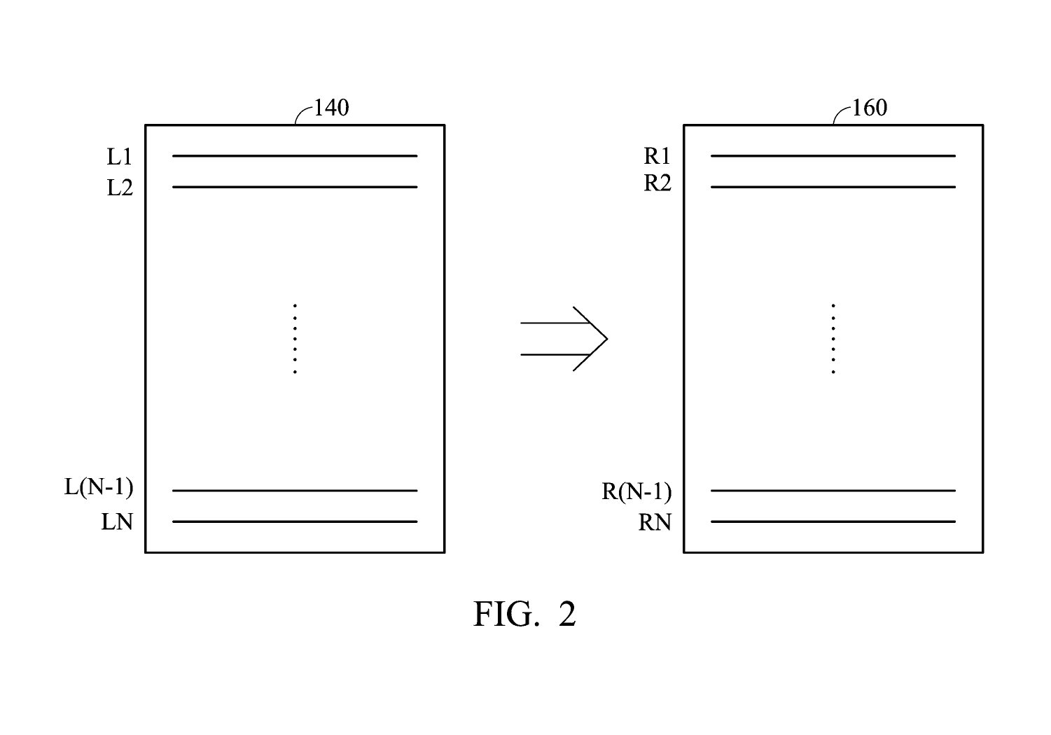

FIG. 2 shows a schematic diagram illustrating content mapping between the frame buffer 140 and the LCD screen 160 of FIG. 1. The frame buffer 140 can be divided into N lines (line L1-line LN) and the LCD screen 160 can also be divided into N lines (line R1-line RN), wherein the frame data stored in each line of the frame buffer 140 can be used to refresh a corresponding line of the LCD screen 160. For example, the frame data stored in the line L1 of the frame buffer 140 can be used to refresh the line R1 of the LCD screen 160. Furthermore, the frame data stored in the lines L1-LN of the frame buffer 140 can be sequentially read out to refresh the LCD screen 160 by the LCD driver IC 150 in a refresh cycle for the LCM 120.

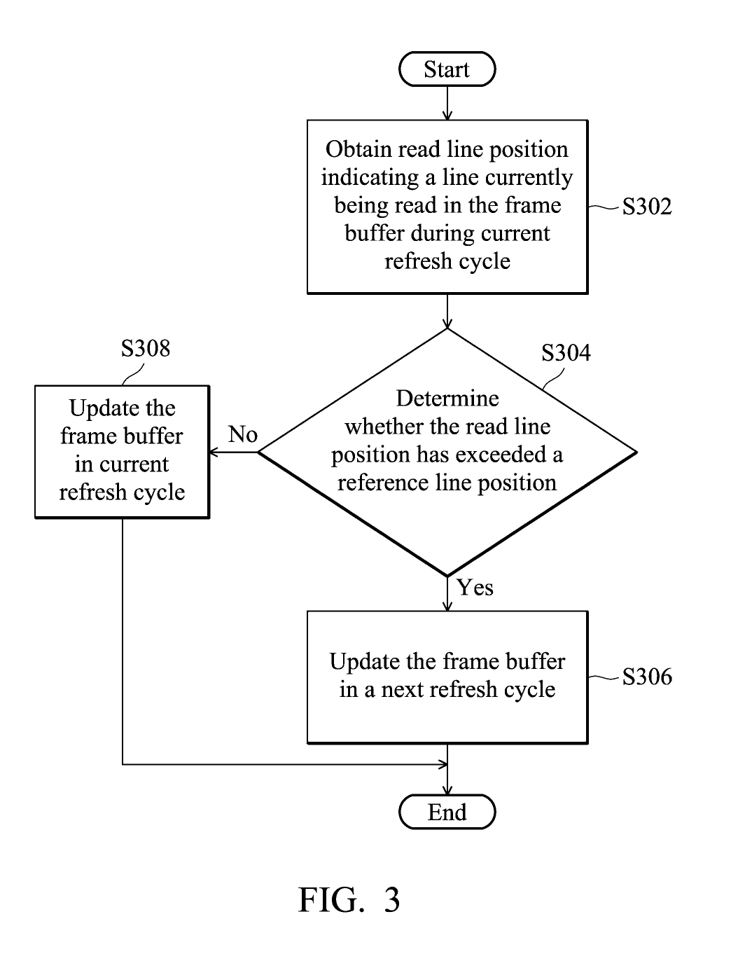

FIG. 3 shows a method for accessing a buffer of a display according to an embodiment of the invention. Referring to FIG. 1 and FIG. 3 together, before writing frame data of at least one frame to update the frame buffer 140, the display controller 130 is capable of obtaining a read line position from the LCD driver IC 150. The read line position indicates a line currently being read in the frame buffer 140 during a current refresh cycle (step S302). In step S304, the display controller 130 is capable of determining whether the read line position has exceeded a reference line position. If yes, the display controller 130 is capable of writing the frame data to update the frame buffer 140 in a next refresh cycle (step S306). Otherwise, the display controller 130 is capable of writing the frame data to update the frame buffer 140 in the current refresh cycle (step S308). It should be noted that, in some embodiments, the steps shown in FIG. 3 can be performed in other orders and some step(s) can be omitted while still within scope of the invention.

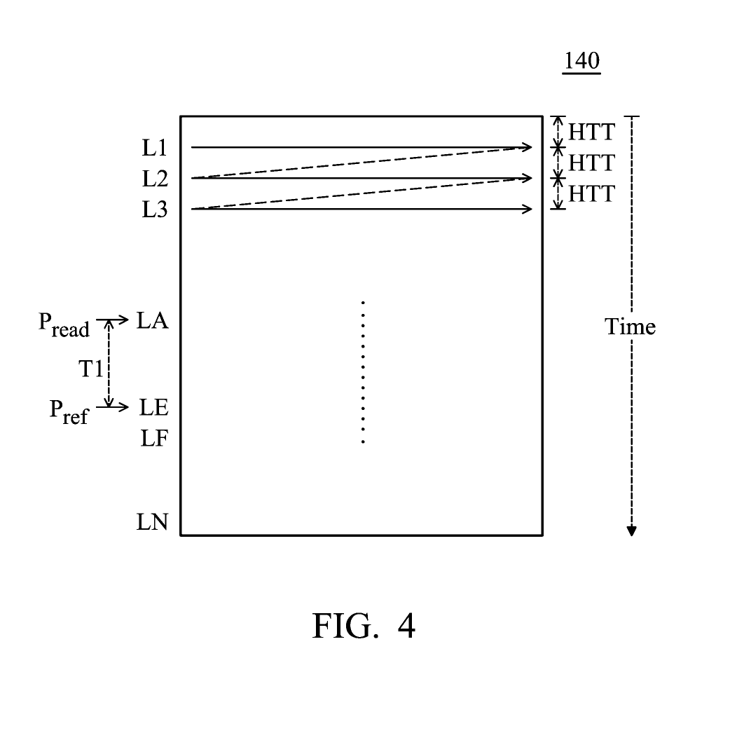

FIG. 4 shows an example illustrating an access status of the frame buffer 140 in FIG. 1 according to an embodiment of the invention. Referring to FIG. 1 and FIG. 4 together, when the display controller 130 wants to update the frame buffer 140, the display controller 130 is capable of obtaining a read line position P_{read} indicating a line LA currently being read by the LCD driver IC 150 during a current refresh cycle (e.g. step S302 of FIG. 3). Then the display controller 130 is capable of determining that the read line position P_{read} is smaller than a reference line position P_{ref} (e.g. step S304 of FIG. 3). In the embodiment, the reference line position P_{ref} is set at a line LE. A reference line position P_{ref} is a target line in every refresh cycle indicating that the display controller 130 can start to write frame data of a new frame into the frame buffer 140 without causing tearing effect. Note that the reference line position P_{ref} may be determined according to various applications. The display controller 130 is capable of delaying a time period T1 to start sending frame data of a new frame, so as to update the frame buffer 140. In the embodiment, the time period T1 can be obtained according to the following formula:

T1=(P_{ref}−P_{read})×HTT,

where HTT represents a read time period for reading one line of the frame buffer 140. In other words, in this embodiment, the display controller 130 does not start to update the frame buffer 140 until the line LE is being read by the LCD driver IC 150. For example, when data of the line LE is being retrieved by the LCD driver IC 150, the display controller 130 can start to write frame data of the new frame to the frame buffer 140 with a sequence from the line L1 to the line LN. Simultaneously, the LCD driver IC 150 can continue to read the frame data from the line LF to the line LN. Specifically, if the read line position P_{read} is smaller than the reference line position P_{ref} in the current refresh cycle, the display controller 130 can start updating the frame buffer 140 during the same refresh cycle (e.g. step S308 of FIG. 3).

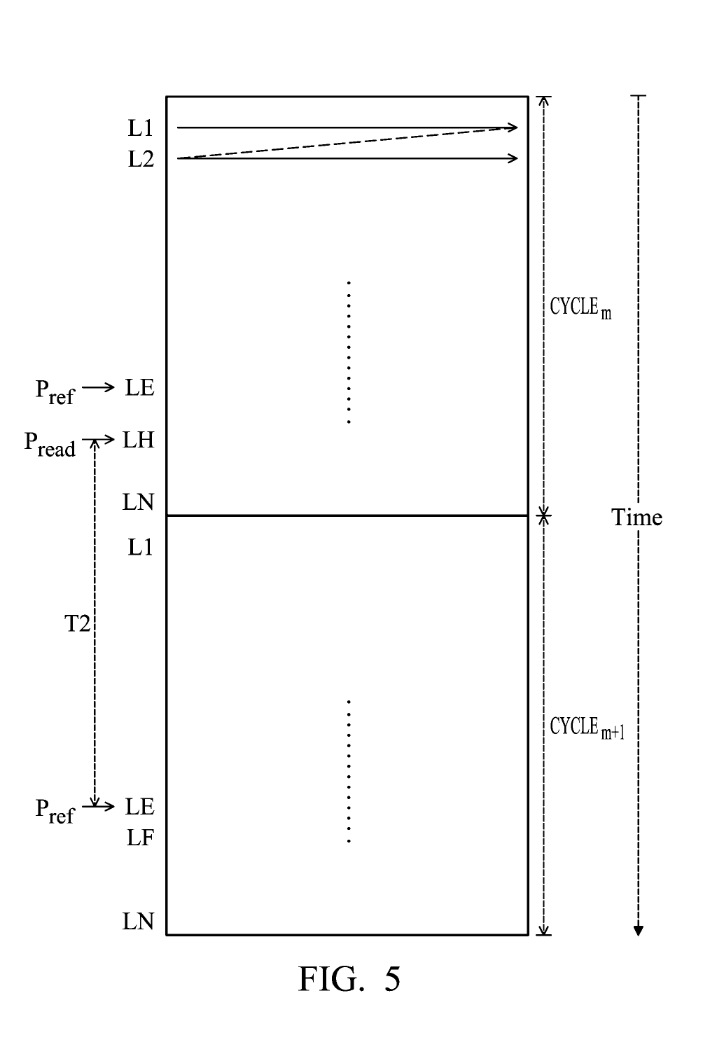

FIG. 5 shows another example illustrating an access status of the frame buffer 140 in FIG. 1 according to an embodiment of the invention. Referring to FIG. 1 and FIG. 5 together, when the display controller 130 wants to update the frame buffer 140, the display controller 130 is capable of obtaining a read line position P_{read} indicating a line LH currently being read by the LCD driver IC 150 during a refresh cycle CYCLEₘ (e.g. step S302 of FIG. 3). Then the display controller 130 is capable of determining that the read line position P_{read} has exceeded a reference line position P_{ref} in the refresh cycle CYCLEₘ (e.g. step S304 of FIG. 3). In the embodiment, the reference line position P_{ref} is set at a line LE. A reference line position P_{ref} is a target line in every refresh cycle indicating that the display controller 130 can start to write frame data of a new frame to the frame buffer 140 without causing tearing effect. Note that the reference line position P_{ref} may be determined according to various applications. The display controller 130 is capable of delaying a time period T2 to start sending frame data of a new frame, so as to update the frame buffer 140. The time period T2 can be larger than the time period T1. In the embodiment, the time period T2 can be obtained according to the following formula:

T2=(P_{ref}−P_{read}+VTT)×HTT,

where HTT represents a read time period for reading one line of the frame buffer 140 and VTT represents a line amount of a frame. In other words, in this embodiment, the display controller 130 does not start to update the frame buffer 140 until a line LE of a next refresh cycle CYCLEₘ₊₁ is being read by the LCD driver IC 150. For example, when data of the line LE is being retrieved by the LCD driver IC 150 in the next refresh cycle CYCLEₘ₊₁, the display controller 130 can start writing frame data of the new frame to the frame buffer 140 with a sequence from the line L1 to the line LN in the refresh cycle CYCLEₘ₊₁. Simultaneously, the LCD driver IC 150 can continue to read the data from the line LF to the line LN in the refresh cycle CYCLEₘ₊₁. Specifically, if the read line position P_{read} is larger than or equal to the reference line position P_{ref} in the refresh cycle CYCLEₘ, the display controller 130 can wait for the next refresh cycle CYCLEₘ₊₁, to start updating the frame buffer 140 (e.g. step S306 of FIG. 3).

In this invention, when to update a frame buffer of a LCM is determined according to a line currently being read and a reference line; thus, tearing effect is decreased without changing PCB and LCM designs.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for accessing a buffer of a display, wherein the buffer is capable of storing frame data of at least one frame and the frame has a plurality of lines, comprising:
obtaining a read line position that indicates a line currently being read in the buffer, wherein the line currently being read is to be shown on a screen of the display; and
delaying a first time period to update the buffer when the read line position is smaller than a reference line position.

2. The method as claimed in claim 1, further comprising:
delaying a second time period to update the buffer when the read line position is larger than or equal to the reference line position.

3. The method as claimed in claim 1, wherein the first time period is obtained according to a value of the reference line position, a value of the read line position, and a read time period which is a time period for reading one line of the frame.

4. The method as claimed in claim 2, wherein the second time period is obtained according to a value of the reference line position, a value of the read line position, a line amount of the frame, and a read time period which is a time period for reading one line of the frame.

5. The method as claimed in claim 1, wherein the line currently being read is used to refresh a corresponding line of the screen in the display.

6. A method for accessing a buffer of a display, wherein the buffer is capable of storing frame data of at least one frame and the frame has a plurality of lines, comprising:
obtaining a read line position that indicates a line currently being read in the buffer, wherein the line currently being read is used to refresh a corresponding line of a screen in the display during a refresh cycle;
starting writing frame data of a new frame into the buffer in the refresh cycle when the read line position is smaller than a reference line position; and
starting writing the frame data of the new frame into the buffer in a next refresh cycle when the read line position is larger than or equal to the reference line position.

7. The method as claimed in claim 6, wherein when the read line position is smaller than the reference line position, the frame data of the new frame is written into the buffer after a first time period is reached.

8. The method as claimed in claim 7, wherein the first time period is obtained according to a value of the reference line position, a value of the read line position, and a read time period which is a time period for reading one line of the frame.

9. The method as claimed in claim 6, wherein when the read line position is larger than or equal to the reference line position, the frame data of the new frame is written into the buffer after a second time period is reached.

10. The method as claimed in claim 9, wherein the second time period is obtained according to a value of the reference line position, a value of the read line position, a line amount of the frame, and a read time period which is a time period for reading one line of the frame.

11. A display device, comprising:
an LCD module, comprising:
a screen;
a buffer, capable of storing frame data of at least one frame to be displayed on the screen, and the frame having a plurality of lines; and
a driver, capable of reading the frame data from the buffer and transferring the read data to the screen; and
a display controller, writing frame data of a new frame into the buffer via the driver after a specific time period is reached, wherein the specific time period is determined according to a read line position indicating a line currently being read by the driver in a refresh cycle.

12. The display device as claimed in claim 11, wherein the line currently being read is used to refresh a corresponding line of the screen during the refresh cycle, and the frame data of the new frame is written into the buffer by the display controller in the refresh cycle when the read line position is smaller than a reference line position.

13. The display device as claimed in claim 12, wherein when the read line position is smaller than the reference line position, the specific time period is obtained according to a value of the reference line position, a value of the read line position, and a read time period which is a time period for reading one line of the frame by the driver.

14. The display device as claimed in claim 11, wherein the line currently being read is used to refresh a corresponding line of the screen during the refresh cycle, and the frame data of the new frame is written into the buffer by the display controller in a next refresh cycle when the read line position is larger than or equal to a reference line position.

15. The display device as claimed in claim 14, wherein when the read line position is larger than or equal to the reference line position, the specific time period is obtained according to a value of the reference line position, a value of the read line position, a line amount of the frame, and a read time period which is a time period for reading one line of the frame by the driver.

16. The display device as claimed in claim 11, wherein when the display controller determines that a target line of the frame has not been read in the refresh cycle according to the read line position, the display controller writes the frame data of the new frame into the buffer via the driver when the target line is being read in the refresh cycle.

17. The display device as claimed in claim 11, wherein when the display controller determines that a target line of the frame has been read in the refresh cycle according to the read line position, the display controller writes the frame data of the new frame into the buffer via the driver when the target line is being read in a next refresh cycle.
